(19) United States
(12) Patent Application Publication
(10) Pub. No.: US 2007/0173586 A1
(43) Pub. Date: Jul. 26, 2007

(54) Powdery, water-soluble cationic polymer composition, method for the production and use thereof

(76) Inventors: Gregor Herth, Krefeld (DE); Bernd Kubiak, Krefeld (DE); Steiner Norbert, Alzenau (DE); Eric Benghozi, Schaffhausen (CH)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/567,664

(22) PCT Filed: May 28, 2004
(86) PCT No.: PCT/EP04/05807

§ 371 Date: Nov. 15, 2006

(30) Foreign Application Priority Data
Aug. 14, 2003 (DE) 103 37 763.8

(51) Int. Cl. C08F 283/00

(52) U.S. Cl. 524/457

(57) ABSTRACT

The invention relates to powdery, water-soluble cationic polymers containing at least two chemically different composed cationic polymers. A first cationic polymer is formed in the presence of a second cationic polymer from the monomer constituents in an aqueous solution according to the aqueous gel polymerisation method. The invention also relates to the use of said products in solid/liquid separation.

The present invention relates to powdery, water-soluble, cationic polymers composed of at least two different cationic polymer components, which are different in terms of cationic components and molecular weight, as well to a method for production of same and to the use of the polymer products for solid-liquid separation, for example as a retention aid in paper manufacture, and in sludge dewatering/wastewater purification.

In the practice of solid-liquid separation, the object is to achieve, by addition of flocculating auxiliaries, the best possible result in terms of the parameters dry substance of the solid and clarity of the filtrate, or in other words to bring about the most complete separation possible of solid from the liquid phase. Sludge dewatering on a chamber-type filter press can be regarded as an example of the importance of these parameters. Since the dried sludge must be transported and often put to beneficial use by thermal processing, the highest possible content of solid (dry-substance content) is desired. In addition, the separated filtrate must be delivered to disposal. The quality and simplicity of such disposal increase as the clarity of the filtrate increases, or in other words as the content of unflocculated solids remaining in the filtrate becomes lower. In such a case the filtrate can be discharged directly from a clarifying plant to the environment, and does not have to pass through the clarifying plant once again. Occasionally a flocculating auxiliary produces a flocculated sludge with high solid content but unsatisfactory clarification of the supernatant. The situation may be the reverse for another flocculating agent.

Flocculating auxiliaries are produced in the form of powdery granules or water-in-water or water-in-oil emulsions, and prior to their use are added in dilute aqueous solutions to the medium to be flocculated. Powdery granules are preferred, since they can be transported more inexpensively by virtue of their almost anhydrous condition and, as in the water-in-oil emulsions, do not contain any oil or solvent constituents that are insoluble in water.

It has been found in practice that the combination of two flocculating auxiliaries often yields better overall results than the use of a single flocculating auxiliary. For example, DE-OS (German Unexamined Application) 1642795 and EP 346159 A1 describe the successive addition of different polymeric flocculating agents.

Mixtures of powdery granules are described in the prior art, for example in WO 99/50188, wherein powders of two oppositely charged flocculating auxiliaries are united in a common solution. By virtue of different dissolution behavior of the two polymer powders, solution products of irregular composition can already be formed during the dissolution operation.

The use of dry powder mixtures of different polymers in flocculation processes can lead to faulty proportioning as a result of phase-separation phenomena.

From EP 262945 A2 there are known cationic flocculation auxiliaries composed of two different polymer components and methods for production of same. They are not obtained by mixing the polymer components together but are formed by polymerization of cationic monomers to a high molecular weight cationic polymer component (flocculent) in the presence of a low molecular weight cationic polymer component (coagulant). During this polymerization reaction, the polymer added first can undergo graft reactions. Because of their incompatibility with the flocculant, which is based on acrylate monomers, the following coagulant polymers are preferably used: polymers of allyl monomers, especially poly-DADMAC and amine-epichlorohydrin polymers (page 4, line 40 et seq.). The ratio of coagulant to the high molecular weight polyelectrolyte component is specified as 10:1 to 1:2, preferably 5:1 to 1:1.5 (page 3, lines 48-49), or in other words the proportion of coagulant in the polymer mixture is 83 to 40 wt % in the preferred embodiment. The high proportions of coagulant cause viscosity problems in the production of polymerization solutions. The properties of the disclosed flocculating agents do not satisfy the requirements of speed and effectiveness imposed on technical flocculation processes.

The object of the present invention was to provide powdery cationic flocculation auxiliaries that are improved compared with the prior art and that are composed of a low molecular weight polymer constituent and a high molecular weight polymer constituent. Another object is to specify a production method by which the two polymer components can be united with one another without substantial restrictions and the reaction products can be further processed without substantial restrictions, and wherein an intrinsically uniform and readily soluble polymer powder is formed.

The object is achieved by a water-soluble, cationic polymer composition that contains at least two cationic polymers of different composition in the cationic groups, wherein a first cationic polymer is formed by radical polymerization of its monomer constituents in the presence of a second cationic polymer in aqueous solution, characterized in that
the polymerization of the first cationic polymer takes place in an aqueous solution of the second cationic polymer according to the method of adiabatic gel polymerization.

In an advantageous embodiment, the polymer composition is formed by a ratio of the second cationic polymer to the first cationic polymer of 0.01:10 to 1:4, preferably 0.2:10 to <1:10.

According to the invention, the two cationic polymers differ in the nature of their cationic groups, which are of different composition, meaning that the first cationic polymer is formed from a cationic monomer species different from that of the second cationic polymer.

The first cationic polymer is a copolymer of cationic and nonionic monomers.

Examples of suitable cationic monomer components are cationized esters of (meth)acrylic acid, such as dimethylaminoethyl(meth)acrylate, diethylaminoethyl(meth)acrylate, diethylaminopropyl(meth)acrylate, dimethylaminopropyl(meth)acrylate, diethylaminopropyl(meth)acrylate, dimethylaminobutyl(meth)acrylate, diethylaminobutyl(meth)acrylate, cationized amides of (meth)acrylic acid, such as dimethylaminoethyl(meth)acrylamide, diethylaminoethyl(meth)acrylamide, diethylaminopropyl(meth)acrylamide, dimethylaminopropyl(meth)acrylamide, diethylaminopropyl(meth)acrylamide, dimethylaminobutyl(meth)acrylamide, diethylaminobutyl(meth)acrylamide, cationized N-alkylmonoamides and diamides with alkyl groups containing 1 to 6 C atoms, such as N-methyl(meth)acrylamide, N,N-dimethylacrylamide, N-ethyl(meth)acrylamide, N-propyl(meth)acrylamide, tert-butyl(meth)acrylamide, cationized N-vinylimidazoles as well as substituted N-vinylimidazoles, such as N-vinyl-2-methylimidazole, N-vinyl-4-methylimidazole, N-vinyl-5-methylimidazole, N-vinyl-2-ethylimidazole and cationized N-vinylimidazolines, such as vinylimidazoline, N-vinyl-2-methylimidazoline and N-vinyl-2-ethylimidazoline.

The basic monomers are used in the form neutralized with mineral acids or organic acids or in quaternized form, in which case quaternization is preferably effected with dimethyl sulfate, diethyl sulfate, methyl chloride, ethyl chloride or benzyl chloride. In a preferred embodiment, the monomers quaternized with methyl chloride or benzyl chloride are used.

Preferred cationic monomer components are the cationized esters and amides of (meth)acrylic acid, in each case containing a quaternized N atom. Particularly preferably there are used quaternized dimethylaminopropylacrylamide and quaternized dimethylaminoethyl acrylate.

Examples of suitable nonionic monomer components, which are preferably water-soluble, are acrylamide, methacrylamide, acrylonitrile, methacrylonitrile, N,N-dimethylacrylamide, vinylpyridine, vinyl acetate, hydroxy-group-containing esters of polymerizable acids the hydroxyethyl and hydroxypropyl esters of acrylic acid and methacrylic acid, further amino-group-containing esters and amides of polymerizable acids, such as the dialkylamino esters, for example dimethylamino and diethylamino esters of acrylic acid and methacrylic acid, a specific example being dimethylaminoethyl acrylate, as well as the corresponding amides, such as dimethylaminopropylacrylamide. Preferably acrylamide is used as the nonionic monomer component. Monomers having limited solubility in water are used only to the extent that they do not impair the water solubility of the resulting copolymer.

The first cationic polymer is a high molecular weight polymer. Its average molecular weight Mw is higher than 1 million, preferably higher than 3 million. The molecular weight of the first cationic polymer is higher than that of the second cationic polymer. The high molecular weight of the first cationic polymer improves the effect of the inventive polymer composition in the flocculation process.

The charge density of the first cationic polymer can be freely selected in principle, and must be matched to the respective application. In one advantageous embodiment, the first cationic polymer is formed from 20 to 90 wt %, preferably 40 to 80 wt % of cationic monomers.

The second cationic polymer can be polymerized from the same cationic monomers as described for the first cationic polymer, albeit supplemented by diallyidimethylammonium chloride monomer.

Preferred cationic for monomers are the cationized esters and amides of (meth)acrylic acid, in each case containing a quaternized N atom. Particularly preferred are quaternized dimethylaminopropylacrylamide and quaternized dimethylaminoethyl acrylate and diallyldimethylammonium chloride.

Besides homopolymers from the monomers cited in the foregoing there can also be used copolymers with preferably water-soluble, nonionic monomers. These are the same nonionic monomers that have already been described for the first cationic polymer. Preferably acrylamide is used as the comonomer.

Monomers having limited solubility in water are used only to the extent that they do not impair the water solubility of the resulting copolymer.

In one advantageous embodiment, the second cationic polymer is formed from 70 to 100 wt %, preferably from 75 to 100 wt % and particularly preferably from 100 wt % of cationic monomers.

The second cationic polymer has lower molecular weight than the first cationic polymer. Its average molecular weight is lower than 1 million, preferably between 50,000 and 700,000 and particularly preferably between 100,000 and 500,000.

In a further advantageous embodiment, the first cationic polymer has a lower cationic charge density than the second cationic polymer.

The inventive water-soluble, cationic polymer compositions are produced by the method of adiabatic gel polymerization, wherein a first cationic polymer is formed by radical polymerization of its monomer constituents in aqueous solution in the presence of a second cationic polymer.

For the reaction, an aqueous solution of cationic and if necessary nonionic monomers and the second cationic polymer is first prepared, the start temperature for the polymerization is adjusted to a range of −10° C. to 25° C., and oxygen is purged from the solution by an inert gas. The exothermic polymerization reaction of the monomers is started by addition of a polymerization initiator, and heating of the polymerization mixture takes place with formation of a polymer gel. After the temperature maximum has been reached, the solid polymer gel being formed can be further processed immediately or else after a holding time. Preferably the polymer gel will be further processed immediately after the maximum temperature has been reached.

The aqueous mixture of monomers and the second cationic polymer is usually prepared in a concentration of 10 to 60 wt %, preferably 15 to 50 wt % and particularly preferably 25 to 45 wt %.

In a preferred embodiment, the solution obtained during polymerization of the second cationic polymer is used directly for production of the inventive products.

The start temperature for the polymerization reaction is adjusted to a range of −10° C. to 25° C., preferably to a range of 0° C. to 15° C. Higher start temperatures lead to polymer gels which are too soft to be further processed in the subsequent size-reduction and drying processes.

The polymerization of the first cationic polymer is performed as an adiabatic polymerization, and it can be started either with a redox system or with a photoinitiator. Moreover, a combination of the two starting options is possible.

The redox initiator system comprises at least two components: An organic or inorganic oxidizing agent and an organic or inorganic reducing agent. For this purpose there are often used compounds with peroxide units, examples being inorganic peroxides such as alkali metal and ammonium persulfate, alkali metal and ammonium perphosphates, hydrogen peroxide and its salts (sodium peroxide, barium peroxide) or organic peroxides such as benzoyl peroxide, butyl hydroperoxide or per acids such as peracetic acid. Besides those, however, other oxidizing agents can also be used, such as potassium permanganate, sodium and potassium chlorate, potassium dichromate, etc. As reducing agents there can be used sulfur-containing compounds such as sulfites, thiosulfates, sulfinic acid, organic thiols (ethylmercaptan, 2-hydroxyethanethiol, 2-mercaptoethylammonium chloride, thioglycolic acid) and others. In addition, ascorbic acid and low-valency metal salts are possible [copper(I); manganese(II); iron(II)]. It is also entirely possible to use phosphorus compounds, such as sodium hypophosphite. In the case of photopolymerization, the reaction is preferably started with UV light, which causes decomposition of the initiator. As examples, benzoin and benzoin derivatives, such as benzoin ether, benzil and its derivatives, such as benzil ketals, acryldiazonium salts, azo initiators such as 2,2′-azobis(isobutyronitrile), 2,2′-azobis(2-amidinopropane)hydrochloride or acetophenone derivatives can be used as initiators. The quantity of the oxidizing and reducing components ranges between 0.00005 and 0.5 wt %, preferably from 0.001 to 0.1 wt %, and that of photoinitiators ranges between 0.001 and 0.1 wt %, preferably 0.002 to 0.05 wt %, relative to the monomer solution.

The polymerization is carried out in aqueous solution, in batches in a polymerization vessel or continuously on an endless belt, as is described, for example, in DE 3544770. This specification is herewith made part of the disclosure by reference. The process is carried out at atmospheric pressure without external supply of heat, a maximum final temperature of 50 to 150° C., depending on the concentration of polymerizable substance, being reached due to the heat of polymerization.

According to this inventive polymerization procedure, there are obtained polymers with decisively better product properties than were measured for products according to EP 262945, which products were synthesized by isothermal polymerization.

After the end of polymerization, the polymer existing as a gel is subjected to size reduction in standard industrial apparatus. The ratio of the second to the first cationic polymer is decisive for further processing of the polymer gel. If the ratio exceeds the value of 0.01:10 to 1:4, there are formed very soft gels, which immediately coalesce once again after size reduction and make drying on the industrial scale almost impossible. Polymers with cationic monomer proportions of greater than 60 wt % are particularly critical as regards further processing. In those cases, it has often proved effective to adjust the ratio of the first to the second cationic polymer to 0.2:10 to <1:10.

After size reduction, the gel is dried in batches in a circulating-air drying oven at 70° C. to 150° C., preferably at 80° C. to 120° C. and particularly preferably at 90° C. to 110° C. In the continuous version, drying takes place in the same temperature ranges, for example on a belt dryer or in a fluidized-bed dryer. After drying, the product preferably has a moisture content of less than or equal to 12%, and particularly preferably of less than or equal to 10%.

After drying, the product is ground to the desired particle-size fraction. In order to achieve rapid dissolution of the product, at least 90 wt % of the product must have a size of smaller than 2.0 mm, and preferably 90 wt % must have a size of smaller than 1.5 mm. Fine fractions smaller than 0.1 mm should amount to less than 10 wt %, preferably less than 5 wt %.

The inventive polymers are suitable as flocculation auxiliaries in the course of solid/liquid separation. In particular, they can be used suitably for purification of wastewater and for conditioning of potable water. Above and beyond this, they can be advantageously used as retention auxiliaries in flocculation processes during paper manufacture.

The invention will be explained hereinafter on the basis of examples. These explanations are provided exclusively by way of example and do not limit the general inventive ideas.

### EXAMPLES

### Determination of the Viscosity of the Polymer

The viscosities were determined with a Brookfield viscometer on a 0.5 wt % solution in 10 wt % NaCl solution. The dissolution time was one hour.

The following abbreviations are used:
ABAH: 2,2′-azobis(2-amidinopropane) hydrochloride
DIMAPA-quat: 3-dimethylammoniumpropyl(meth)acrylamide, which has been quaternized with methyl chloride
ADAME-quat: 2-dimethylammoniummethyl(meth)acrylate, which has been quaternized with methyl chloride
DADMAC diallyldimethylammonium chloride

### Second Cationic Polymer

The second cationic polymers used in the examples are solution polymers of DADMAC and DIMAPA-quat, which were produced with various polymer contents and various molecular weights (Mw according to GPC). The properties of these products are listed in more detail in the table:

| | | Polymer | Molecular |
|---|---|---|---|
| | Type | content | weight |
| K1 | Poly-DADMAC | 40% | 300,000 |
| K2 | Poly-DIMAPA- | 25% | 1,000,000 |
| | quat | | |
| K3 | Poly-DIMAPA- | 40% | 100,000 |
| | quat | | |
| K4 | Poly-DIMAPA- | 25% | 500,000 |
| | quat | | |

### Determination of the Dewatering Effect by the Screen-Test Method

This test method is adapted to dewatering methods used in industry, namely continuous pressure filtration by means of filter presses or centrifugal dewatering in centrifuges.

By means of this method, organic cationic polymers are usually tested with regard to their suitability for conditioning and dewatering of communal or industrial sludges.

Using the flocculation-auxiliary solution to be tested, the sludge is conditioned under constant conditions (depending on the existing dewatering equipment). After conditioning, the sludge sample is filtered (=dewatered) on a metal screen (200 μm mesh openings). The dewatering time (t_{E}) for a predefined volume of filtrate is measured, and the clarity of the collected filtrate is evaluated in a clarity wedge (optically).

| | | |
|---|---|---|
| Clarity: | “0” = | no clarification |
| Clarity: | “46” = | best clarification |

### Inventive Polymers

The inventive polymers are produced by the method of gel polymerization.

### Polymer 1

390.0 g of 50 wt % aqueous acrylamide solution was first placed in a polymerization vessel and 164.0 g of water as well as 210 mg of Versenex 80 was mixed in. After the addition of 325.0 g of 60 wt % DIMAPA-quat and 90.0 g of the 40 wt % solution of K1, the pH was adjusted to 5.0 with 4.0 g of 50 wt % sulfuric acid and the mixture was cooled to 0° C. and purged with nitrogen. After the addition of 0.45 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Polymer 2

280.0 g of 50 wt % aqueous acrylamide solution was first placed in a polymerization vessel and 150.7 g of water as well as 210 mg of Versenex 80 was mixed in. After the addition of 433. g of 60 wt % DIMAPA-quat and 130.0 g of the 40 wt % solution of K1, the pH was adjusted to 5.0 with 6.0 g of 50 wt % sulfuric acid and the mixture was cooled to 0° C. and purged with nitrogen. After the addition of 0.45 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Polymer 3

378.0 g of 50 wt % aqueous acrylamide solution was first placed in a polymerization vessel and 303.6 g of water as well as 210 mg of Versenex 80 was mixed in. After the addition of 260.0 g of 80 wt % ADAME-quat and 57.8 g of the 40 wt % solution of K3, the pH was adjusted to 5.0 with 0.6 g of 50 wt % sulfuric acid and the mixture was cooled to 0° C. and purged with nitrogen. After the addition of 0.45 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Polymer 4

The synthesis was carried out as for polymer 3, except that 29.0 g of the 40 wt % solution of K3, 274.3 g of 80 wt % ADAME-quat and 318.2 g of water were added.

### Polymer 5

The synthesis was carried out as for polymer 3, except that 78.8 g of the 40 wt % solution of K3, 354.4 g of 80 wt % ADAME-quat, 270.0 g of 50 wt % acrylamide solution and 296.1 g of water were added.

### Polymer 6

The synthesis was carried out as for polymer 3, except that 39.4 g of the 40 wt % solution of K3, 374.1 g of 80 wt % ADAME-quat, 270.0 9 of 50 wt % acrylamide solution and 316.0 g of water were added.

### Polymer 7

The synthesis was carried out as for polymer 2, except that 70.0 g of K1 and 210.7 g of water were used.

### Polymer 8

The synthesis was carried out as for polymer 2, except that 90.0 g of K1 and 192.4 g of water were used.

### Polymer 9

The synthesis was carried out as for polymer 1, except that 64.8 g of K1, 253.5 g of water, 370 g of acrylamide solution and 308.5 g of DIMAPA-quat solution were used.

### Polymer 10

The synthesis was carried out as for polymer 1, except that 83.3 g of K1, 235.1 g of water, 370 g of acrylamide solution and 308.5 g of DIMAPA-quat solution were used.

Examples of the Start Temperature

Higher start temperatures lead to softer gels, since the molecular weights become lower. This could be prevented with a lower monomer concentration. In both cases, however, gels that can no longer be processed are formed. In general, therefore, start temperatures higher than 25° C. are not possible according to the inventive method, which includes size reduction of the gel and drying.

### Polymer 11

The synthesis was carried out as described for polymer 1, but was started at 10° C.

### Polymer 12

The synthesis was carried out as described for polymer 1, but was started at 15° C.

### Polymer 13

The synthesis was carried out as described for polymer 1, but was started at 20° C.

### Comparison Polymers

### Comparison Polymer 1

407.0 g of 50 wt % aqueous acrylamide solution was first placed in a polymerization vessel and 312.7 g of water as well as 0.15 g of Versenex 80 was mixed in. After the addition of 277.50 g of 60 wt % DIMAPA-quat, the pH was adjusted to 5.0 with 2.8 g of 50 wt % sulfuric acid and 0.30 g of formic acid, and the mixture was cooled to 0° C. and purged with nitrogen. After the addition of 0.40 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Comparison Polymer 2

240.0 g of 50 wt % aqueous acrylamide solution was first placed in a polymerization vessel and 285.3 g of water as well as 210 mg of Versenex 80 was mixed in. After the addition of 466.7 g of 60 wt % DIMAPA-quat, the pH was adjusted to 5.0 with 8.0 g of 50 wt % sulfuric acid and 0.30 g of formic acid, and the mixture was cooled to 0° C. and purged with nitrogen. After the addition of 0.40 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Comparison Polymer 3

342.0 g of 50 wt % aqueous acrylamide solution was first placed in a polymerization vessel and 394.7 g of water as well as 210 mg of Versenex 80 was mixed in. After the addition of 261.3 g of 80 wt % ADAME-quat, the pH was adjusted to 5.0 with 2.0 g of 50 wt % sulfuric acid, and the mixture was cooled to 0° C. and purged with nitrogen. After the addition of 0.40 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Comparison Polymer 4

270.0 g of 50 wt % aqueous acrylamide solution was first placed in a polymerization vessel and 335.5 g of water as well as 210 mg of Versenex 80 was mixed in. After the addition of 393.8 g of 80 wt % ADAME-quat, the pH was adjusted to 5.0 with 2.0 g of 50 wt % sulfuric acid, and the mixture was cooled to 0° C. and purged with nitrogen. After the addition of 0.40 g of ABAH (2,2′-azobis(2-methylpropionamidine)dihydrochloride), the polymerization was started with UV light. Within 25 minutes, the polymerization went from 0° C. to 80° C. The polymer was subjected to size reduction with a meat grinder and dried at 100° C. for 90 minutes. The product was ground to a particle-size fraction of 90 to 1400 μm.

### Comparison Polymer 5

A mixture of 133.3 g of 75 wt % MADAME-quat solution, 250 g of K1 and 283.7 g of water was purged with nitrogen and heated to 70° C. After the addition of 3.0 mL of a 2 wt % methanolic AIBN solution, the mixture was stirred for 3 hours at 70° C. (isothermally). The product viscosity was 19000 mPas.

### Comparison Polymer 6

The synthesis was carried out as in Comparison Example 5, except that 250.0 g of K1, 106.7 g of MADAME-quat, 40.0 g of acrylamide and 270.3 g of water were used.

### Comparison Polymer 7 (According to EP 262945 B1)

The synthesis was carried out as in Comparison Example 5, except that 250.0 g of K1, 80.0 g of MADAME-quat, 80.0 g of acrylamide and 257.3 g of water were used.

### Comparison Polymer 8 (According to EP 262945 B1)—Start Temperature

The synthesis was carried out as in Comparison Example 6, but was started at 3° C. with 1000 ppm of Na₂S₂O₈, 7 ppm of FeSO₄ and 2000 ppm of Na₂S₂O₅. The temperature the preparation rose to 33° C. in 24 minutes. Thereafter the mixture was stirred for another 60 minutes.

### Comparison Polymer 9 (According to EP 262945 B1)—Start Temperature

The synthesis was carried out as in Comparison Example 7, but was started at 3° C. with 500 ppm of Na₂S₂O₈, 7 ppm of FeSO₄ and 1000 ppm of Na₂S₂O₅. The temperature the preparation rose to 31° C. in 40 minutes. Thereafter the mixture was stirred for another 60 minutes.

### Application Examples

The experiments on application were actually all performed on Ilverich sludge, but the sludge was sampled on different days and so the values occasionally fluctuate for the same polymer/sludge combination. The same sludge batch was always used within a given example. As is known to those skilled in the art, the properties of the clarification sludge of a clarifying plant can fluctuate with time.

### Application Example 1

Inventive polymer 1 was compared with comparison polymer 1 as well as with separate addition of second cationic polymer followed by first cationic polymer in the form of the comparison polymers without the second cationic polymer. The stirring time was 10 s and the filtrate volume was 200 mL.

| | | | |
|---|---|---|---|
| Added quantity [kg AS per metric ton DS] | 3.9 | 4.2 | 4.5 |
| Added quantity [g AS per m³] | 120 | 130 | 140 |
| Comparison polymer 1 | 37 s | 22 s | 18 s |
| | 20 | 26 | 29 |
| Comparison polymer 1 with 10% K2 | 33 s | 24 s | 19 s |
| | 25 | 28 | 29 |
| Comparison polymer 1 with 10% K3 | 34 s | 21 s | 20 s |
| | 26 | 29 | 30 |
| Comparison polymer 1 with 10% K4 | 32 s | 18 s | 17 s |
| | 25 | 29 | 30 |
| Polymer 1 | 29 s | 16 s | 15 s |
| | 28 | 41 | 43 |

AS: polymer quantity (“active substance”),
DS: dry substance in the clarification sludge
Data in s = time for 200 mL of filtrate;
bold type = clarity of the solution

### Application Example 2

Inventive polymer 2 was compared with comparison polymer 2 as well as with separate addition of second cationic polymer followed by first cationic polymer in the form of the comparison polymers without a proportion of the second cationic polymer. The stirring time was 10 s and the filtrate volume was 200 ml.

| | | | |
|---|---|---|---|
| Added quantity [kg AS per metric ton DS] | 4.2 | 4.5 | 4.8 |
| Added quantity [g AS per m³] | 130 | 140 | 150 |
| Comparison polymer 2 | 35 s | 25 s | 16 s |
| | 23 | 28 | 34 |
| Comparison polymer 2 with 10% K2 | 35 s | 25 s | 16 s |
| | 26 | 31 | 34 |
| Comparison polymer 2 with 10% K3 | 44 s | 28 s | 22 s |
| | 27 | 33 | 36 |
| Comparison polymer 2 with 10% K4 | 40 s | 31 s | 23 s |
| | 28 | 32 | 35 |
| Polymer 2 | 32 s | 20 s | 18 s |
| | 32 | 39 | 40 |

AS: polymer quantity (“active substance”),
DS: dry substance in the clarification sludge
Data in s = time for 200 mL of filtrate;
bold type = clarity of the solution

### Application Example 3

Inventive polymers 3, 4, 5 and 6 were compared with comparison polymers 3 and 4. The stirring time was 10 s and filtrate volume was 200 mL.

| | | | |
|---|---|---|---|
| Added quantity [kg AS per metric ton DS] | 4.1 | 4.7 | 5.3 |
| Added quantity [g AS per m³] | 120 | 130 | 140 |
| Comparison polymer 3 | 16 s | 10 s | 5 s |
| | 14 | 22 | 35 |
| Polymer 3 | 25 s | 11 s | 6 s |
| | 17 | 24 | 42 |
| Polymer 4 | 18 s | 12 s | 4 s |
| | 18 | 24 | 46 |
| Added quantity [kg AS per metric ton DS] | 4.1 | 4.7 | 5.3 |
| Added quantity [g AS per m³] | 120 | 130 | 140 |
| Comparison polymer 4 | 40 s | 19 s | 12 s |
| | 14 | 26 | 44 |
| Polymer 5 | 25 s | 15 s | 8 s |
| | 23 | 46 | 46 |
| Polymer 6 | 25 s | 15 s | 8 s |
| | 15 | 38 | 46 |

AS: polymer quantity (“active substance”),
DS: dry substance in the clarification sludge
Data in s = time for 200 mL of filtrate;
bold type = clarity of the solution

From the results of application examples 1 to 3, it is evident that the inventive polymers have a better effect when rate of filtration and clarity of the filtrate are considered as the two parameters for effect.

### Application Example 4

Inventive polymers 7, 8, 9 and 10 were compared with comparison polymers 1, 5, 6 and 7.

The stirring time was 10 s and the filtrate volume was 200 mL.

| | | | |
|---|---|---|---|
| Added quantity [kg AS per metric ton DS] | 3.7 | 4.4 | 5.2 |
| Added quantity [g AS per m³] | 160 | 170 | 180 |
| Comparison polymer 1 | 52 s | 33 s | 18 s |
| | 34 | 38 | 44 |
| Polymer 7 | 35 s | 16 s | 9 s |
| | 40 | 46 | 46 |
| Polymer 8 | 38 s | 16 s | 12 s |
| | 44 | 46 | 46 |
| Polymer 9 | 24 s | 13 s | 8 s |
| | 44 | 46 | 46 |
| Polymer 10 | 26 s | 16 s | 10 s |
| | 44 | 46 | 46 |
| Comparison polymer 5 | >100 s | >100 s | >100 s |
| | 0 | 0 | 0 |
| Comparison polymer 6 | >100 s | >100 s | >100 s |
| | 0 | 0 | 0 |
| Comparison polymer 7 | >100 s | >100 s | >100 s |
| | 0 | 0 | 0 |

AS: polymer quantity (“active substance”),
DS: dry substance in the clarification sludge

The comparison examples according to EP 262945 B1 are much poorer than the inventive polymers. When added in quantities at which the inventive polymers yield good dewatering results, the comparison examples still do not achieve dewatering that even approximates satisfactory performance.

### Application Example 5

Inventive polymers 11, 12 and 13 were compared with comparison polymers 1, 8 and 9. The stirring time was 10 s and the filtrate volume was 200 mL.

| | | | |
|---|---|---|---|
| Added quantity [kg AS per metric ton DS] | 4.8 | 5.2 | 5.5 |
| Added quantity [g AS Per m³] | 160 | 170 | 180 |
| Comparison polymer 1 | 52 s | 46 s | 43 s |
| | 12 | 18 | 22 |
| Comparison polymer 1 with 10% K1 | 54 s | 50 s | 45 s |
| | 16 | 26 | 31 |
| Comparison polymer 1 with 10% K3 | 52 s | 48 s | 47 s |
| | 18 | 22 | 25 |
| Polymer 11 | 17 s | 12 s | 10 s |
| | 34 | 40 | 46 |
| Polymer 12 | 21 s | 18 s | 13 s |
| | 31 | 36 | 40 |
| Polymer 13 | 23 s | 19 s | 16 s |
| | 32 | 35 | 39 |
| Comparison polymer 8 | >100 s | >100 s | >100 s |
| | 0 | 0 | 0 |
| Comparison polymer 9 | >100 s | >100 s | >100 s |
| | 0 | 0 | 0 |

AS: polymer quantity (“active substance”),
DS: dry substance in the clarification sludge
Data in s = time for 200 mL of filtrate;
bold type = clarity of the solution

### Application Example 6

Clarifying Plant

A cationic polyacrylamide (Praestol® 644 BC, a commercial product of Stockhausen GmbH & Co. KG on the basis of 55 wt % of DIMAPA-quat and 45 wt % of acrylamide) was compared with polymer 2 in terms of flocculating power on communal clarification sludge in a clarifying plant.

It was found that 2.85 kg per metric ton of dry substance was needed for flocculation in the case of inventive polymer 2, whereas 4.1 kg per metric ton of dry substance was needed when Praestol® 644 BC was used. Furthermore, 38.5% of dry substance was achieved in the filter cake with polymer 2, representing a 1% improvement compared with Praestol 644 BC. An experiment with the product CS 257, a cationic polymer of Nalco on the basis of 70 wt % of ADAM-quat and 30 wt % of acrylamide, achieved only 36% of dry substance for a consumption of 5.4 kg per metric ton of dry substance.

1. A powdery, water-soluble, cationic polymer composition comprising:
at least two cationic polymers of different composition in the cationic groups, wherein a first cationic polymer is formed by radical polymerization of monomer constituents in the presence of a second cationic polymer in an aqueous solution,
wherein the polymerization of the first cationic polymer takes place in an aqueous solution of the second cationic polymer according to the method of adiabatic gel polymerization, and the ratio of the second to the first cationic polymer is between 0.01:10 and 1:4.

2. A composition according to claim 1, wherein the first cationic polymer has a weight-average molecular weight higher than 1 million.

3. A composition according to claim 1, wherein the second cationic polymer has a weight-average molecular weight lower than 1 million.

4. A composition according to claim 1, wherein the first cationic polymer is formed using cationic monomers selected from the group of cationized esters and amides of (meth)acrylic acid, in each case containing a quaternized N atom.

5. A composition according to claim 1, wherein the second cationic polymer is formed using cationic monomers selected from the group comprising diallyldimethylammonium chloride and the cationized esters and amides of (meth)acrylic acid, in each case containing a quaternized N atom, preferably quaternized dimethylaminopropylacrylamide, quaternized dimethylaminoethyl acrylate and/or diallyldimethylammonium chloride.

6. A composition according to claim 4, wherein copolymerized with further, nonionic water-soluble monomers.

7. A composition according to claim 1, wherein the first cationic polymer is composed of 20 to 90 wt % of cationic monomers.

8. A composition according to claim 1, wherein the second cationic polymer is composed of 70 to 100 wt % of cationic monomers.

9. A composition according to claim 1, wherein the first cationic polymer has a lower charge density than the second cationic polymer.

10. A method for producing polymer compositions of claim 1, the method comprising:
providing polymers that comprise at least two cationic polymers of different composition in the cationic groups, wherein a first cationic polymer is subjected to radical polymerization by adiabatic gel polymerization of the monomer constituents in the presence of a second cationic polymer in aqueous solutions and the ratio of the second to the first cationic polymer is between 0.01:10 and 1:4,
preparing the aqueous solution of cationic monomers and the second cationic polymer with a concentration of 10 to 60 wt %, wherein the start temperature for the polymerization is adjusted to a range of −10° C. to 25° C., and oxygen is purged by an inert gas,
starting the exothermic polymerization reaction of the monomers by adding a polymerization initiator, and heating the polymerization mixture and forming a polymer gel up to its maximum temperature, and
subjecting the polymer gel to mechanical size reduction and drying the polymer gel after the maximum temperature has been reached.

11. The method according to claim 10, wherein the start temperature of polymerization is adjusted to a range of 0° C. to 15° C.

12. The method according to claim 10, wherein the concentration of the aqueous solution of monomers and the second cationic polymer is 15 to 50 wt %.

13. The method according to claim 10, wherein the polymerization initiator comprises a redox system or a system that can be activated by UV radiation.

14. The method according to claim 10, wherein the polymerization is carried out on a polymerization belt.

15. The method according to claim 10, wherein after size reduction, the aqueous polymer gel is dried at temperatures of 80° C. to 120° C. to a moisture content of less than or equal to 12.

16. A method for promoting flocculation during solid/liquid separation, the method comprising:
adding the polymer composition of claim 1 to a mixture of solids and liquids.

17. The method according to claim 16, wherein the solid/liquid separation is for purification of wastewaters and for conditioning of potable water.

18. The method according to claim 16, wherein the solid/liquid separation is during paper manufacture.

19. A composition according to claim 4, wherein the group of cationic monomers includes quaternized dimethylaminopropylacrylamide and quaternized dimethylaminoethyl acrylate.

20. A composition according to claim 5, wherein the group of cationic monomers includes quaternized dimethylaminopropylacrylamide, quaternized dimethylaminoethyl acrylate and/or diallyldimethylammonium chloride.
